(19) United States
(12) Patent Application Publication
(10) Pub. No.: US 2026/0169505 A1
(43) Pub. Date: Jun. 18, 2026

(54) DRIVING DEVICE

(71) Applicant: STANLEY ELECTRIC CO., LTD., Tokyo (JP)

(72) Inventor: Naoya MATSUMARU, Tokyo (JP)

(73) Assignee: STANLEY ELECTRIC CO., LTD., Tokyo (JP)

(21) Appl. No.: 19/417,355

(22) Filed: Dec. 12, 2025

(30) Foreign Application Priority Data
Dec. 16, 2024 (JP) 2024-219632

(51) Int. Cl. G05D 3/14; G02B 26/08; G02B 26/10

(52) U.S. Cl. CPC G05D 3/1418; G02B 26/0833; G02B 26/101

(57) ABSTRACT

A driving device includes a driven mechanism to be driven by a drive signal to operate with a mechanical motion, a driver to output the drive signal, a sensor circuit to output a subject signal corresponding to a voltage that is generated by a sensor included in the driven mechanism and varies in accordance with operation of the driven mechanism, a regulator to adjust the amplitude and phase of a signal from the driver and thus generate a reference signal, and a comparator to compare the reference signal and the subject signal and output a comparison signal for detection of an anomaly in the driven mechanism.

### CROSS-REFERENCE TO RELATED APPLICATION

This application claims the benefit of Japanese Patent Application No. 2024-219632, filed on Dec. 16, 2024, the entire disclosure of which is incorporated by reference herein.

### FIELD OF THE INVENTION

This application relates to a driving device.

### BACKGROUND OF THE INVENTION

Anomaly detection units have been known for detecting an anomaly in a driven mechanism driven by a drive signal to operate with a mechanical motion. For example, Unexamined Japanese Patent Application Publication No. 2023-160273 discloses an abnormality detection device for an optical deflector including a mirror section, support sections that support the mirror section, an actuator that causes the mirror section to swing about the swing axes relative to the support sections in response to an applied drive signal, and a sensor section that outputs a sensor signal in accordance with a swing motion of the mirror section. This abnormality detection device generates predicted data on the basis of a result of calculation of the phase difference between the drive signal and the sensor signal in the optical deflector, and compares the predicted data and data generated by A/D converting the sensor signal, to detect an anomaly in the sensor signal.

### SUMMARY OF THE INVENTION

A driving device according to an aspect of the present disclosure includes: a driven mechanism to be driven by a drive signal to operate with a mechanical motion; a driver to output the drive signal; a sensor circuit to output a subject signal, the subject signal corresponding to a voltage generated by a sensor included in the driven mechanism, the voltage varying in accordance with operation of the driven mechanism; a regulator to adjust an amplitude and a phase of a signal from the driver, and thus generate a reference signal; and a comparator to compare the reference signal and the subject signal, and output a comparison signal for detection of an anomaly in the driven mechanism.

### BRIEF DESCRIPTION OF DRAWINGS

A more complete understanding of this application can be obtained when the following detailed description is considered in conjunction with the following drawings, in which:

FIG. 1 is a block diagram illustrating a configuration of a lighting system according to an embodiment of the present disclosure;

FIG. 2 is a block diagram illustrating a configuration of a drive circuit of the lighting system according to the embodiment of the present disclosure;

FIG. 3 is a block diagram illustrating a configuration of a sensor circuit of the lighting system according to the embodiment of the present disclosure;

FIG. 4 illustrates a configuration of an amplitude regulator of the lighting system according to the embodiment of the present disclosure;

FIG. 5 illustrates a configuration of a phase regulator of the lighting system according to the embodiment of the present disclosure;

FIG. 6 illustrates a configuration of a comparator of the lighting system according to the embodiment of the present disclosure;

FIG. 7A is a schematic diagram illustrating an input or output waveform of each functional block of the lighting system according to the embodiment of the present disclosure, or a waveform diagram of a branched drive signal output from a driver;

FIG. 7B is a schematic diagram illustrating an input or output waveform of each functional block of the lighting system according to the embodiment of the present disclosure, or a waveform diagram of a subject signal and a reference signal input to the comparator;

FIG. 7C is a schematic diagram illustrating an input or output waveform of each functional block of the lighting system according to the embodiment of the present disclosure, or a waveform diagram of a comparison signal output from the comparator;

FIG. 8 illustrates a comparative example in which an existing system detects an anomaly from a result of conversion by an A/D converter;

FIG. 9 illustrates a modification of the lighting system according to the embodiment of the present disclosure;

FIG. 10 illustrates another modification of the lighting system according to the embodiment of the present disclosure;

FIG. 11 illustrates another modification of the lighting system according to the embodiment of the present disclosure;

FIG. 12 illustrates another modification of the lighting system according to the embodiment of the present disclosure; and

FIG. 13 illustrates another modification of the lighting system according to the embodiment of the present disclosure.

### DETAILED DESCRIPTION OF THE INVENTION

A lighting system including an anomaly detection unit according to an embodiment of the present disclosure is described below with reference to the accompanying drawings. In these drawings, the components identical or corresponding to each other are provided with the same reference symbol.

FIG. 1 is a block diagram illustrating a configuration of a lighting system 1. Examples of the lighting system 1 include a light detection and ranging (LiDAR) system that measures the distance to a subject by emitting a laser beam and detecting the beam reflected from by the subject, and an image projection system that projects an image onto a screen. The lighting system 1 includes a light source 2, a light source driver 3 that drives the light source 2, a driving device 4, and a controller 5 that controls operation of the lighting system 1.

A typical example of the light source 2 is a laser diode. In an exemplary LiDAR system, the light source 2 emits a pulsed near-infrared laser beam having a wavelength of approximately 900 nm. The LiDAR system further includes a receiver (not illustrated) that receives the beam emitted from the light source 2 and reflected by the subject.

The driving device 4 drives a driven mechanism driven by a drive signal to operate with a mechanical motion. A typical example of the driving device 4 is an optical deflecting device. The optical deflecting device causes an optical deflector 41 to scan the subject by the beam emitted from the light source 2. The optical deflector 41 corresponds to the driven mechanism and includes a micro-electro-mechanical system (MEMS) mirror, for example. The optical deflector 41 reflects the beam incident from a certain direction, by the mirror rotatable about the two axes perpendicular to each other, and outputs the reflected beam for scanning the subject. The driving device 4 includes a piezoelectric, electrostatic, or electromagnetic actuator to actuate the optical deflector 41.

The driving device 4 includes a driver 42 that feeds a drive signal for driving the actuator of the optical deflector 41. The optical deflector 41 is provided with a sensor 43 that detects operation of the optical deflector 41 with a mechanical motion. The sensor 43 generates, as a sensor signal, a voltage that varies in accordance with the operation, and inputs the generated sensor signal to a sensor circuit 44. The sensor circuit 44 then outputs the sensor signal to the controller 5.

The controller 5 feeds the driver 42 with a control signal, or digital data on the drive signal, to control operation of the actuator of the optical deflector 41. In accordance with the fed control signal, the driver 42 applies the drive signal for driving the actuator to the actuator.

The driving device 4 further includes an anomaly detection unit 45 that detects an anomaly, such as failure, in the optical deflector 41. The anomaly detection unit 45 receives a signal from the driver 42 and a subject signal from the sensor circuit 44. The subject signal matches the sensor signal in frequency and phase. The subject signal is generated by the sensor circuit 44 by adjusting the amplitude ratio of the sensor signal. The anomaly detection unit 45 outputs a signal indicating a result of detection by the anomaly detection unit 45, to the controller 5. The anomaly detection unit 45 includes a regulator including an amplitude regulator 451 that adjusts the amplitude of the signal from the driver 42 and a phase regulator 452 that adjusts the phase of the resulting signal, and a comparator 453 that compares the subject signal with a reference signal generated by adjusting the amplitude and phase of the signal from the driver 42.

The driver 42 outputs, to the amplitude regulator 451 of the anomaly detection unit 45, a signal having the same waveform (for example, sine, triangular, or sawtooth waveform) and the same frequency as the drive signal. The amplitude regulator 451 adjusts the amplitude of the signal input from the driver 42 to a predetermined value or to a value having a predetermined ratio to the original amplitude of the signal from the driver 42.

The signal from the driver 42, after the amplitude adjustment by the amplitude regulator 451, is then input to the phase regulator 452. The phase regulator 452 adjusts the phase of the input signal to have a predetermined phase difference from the signal from the driver 42 after the amplitude adjustment. The phase regulator 452 thus generates the reference signal to be compared with the subject signal by the subsequent comparator 453. The reference signal matches the subject signal in frequency, amplitude, and phase, under normal operation of the optical deflector 41. Although the signal from the driver 42 undergoes the amplitude adjustment by the amplitude regulator 451 and then the phase adjustment by the phase regulator 452 in the above example, the signal may also undergo the phase adjustment by the phase regulator 452 and then the amplitude adjustment by the amplitude regulator 451.

The signal from the driver 42, after the amplitude and phase adjustment by the amplitude regulator 451 and the phase regulator 452, is then input to the comparator 453 in the form of the reference signal, as described above. The comparator 453 also receives the subject signal from the sensor circuit 44, to be compared with the reference signal. The received subject signal matches the sensor signal in frequency and phase as described above, has an adjusted amplitude ratio, and has experienced no A/D conversion. The comparator 453 compares the subject signal with the reference signal. When these signals are different from each other, the comparator 453 outputs a comparison signal for detection of an anomaly. The comparison signal from the comparator 453 is fed to the controller 5. The controller 5 has a function of a determiner for determining an anomaly, and determines the existence of an anomaly on the basis of the comparison signal input from the comparator 453. The determiner may also be an anomaly notification unit independent from the controller 5, for example.

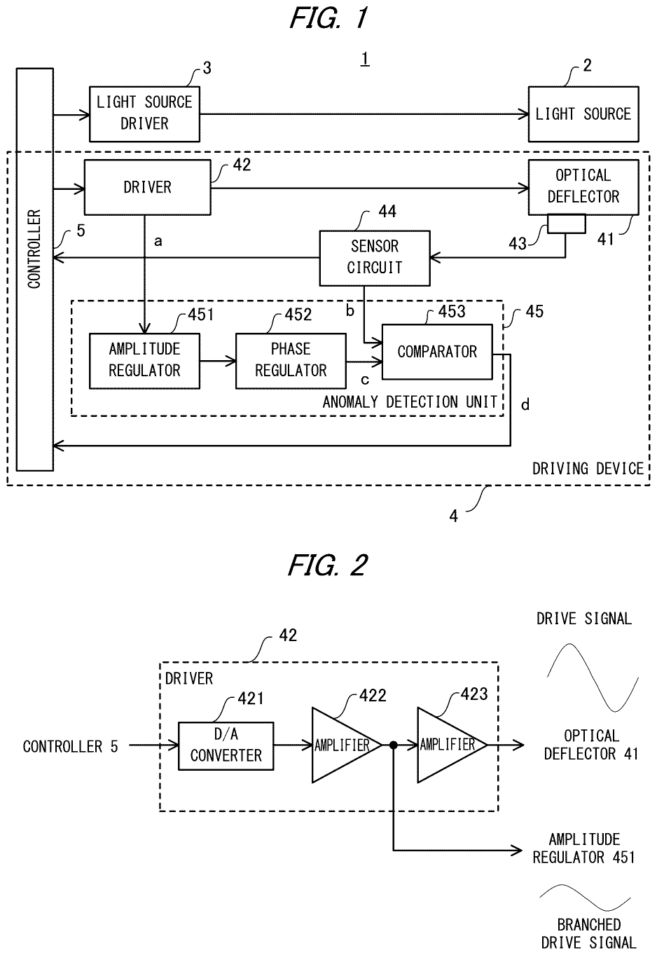

FIG. 2 is a block diagram illustrating specific components of the driver 42. The driver 42 includes a D/A converter 421, a first amplifier 422 that amplifies the D/A-converted drive signal, and a second amplifier 423. The D/A converter 421 of the driver 42 receives, from the controller 5, drive data corresponding to the control signal for driving the actuator. The D/A converter 421 generates the drive signal through D/A conversion of the drive data from the controller 5 followed by amplification by the first amplifier 422 and the second amplifier 423, and outputs the generated drive signal to the actuator of the optical deflector 41. The driver 42 includes an

output branching from the signal path between the output of the first amplifier 422 and the input of the second amplifier 423, to output a branched drive signal corresponding to the signal from the driver 42 from the branching output. The branched drive signal, which is output from the first amplifier 422, has an amplitude ratio smaller than that of the drive signal by a factor corresponding to the degree of amplification of the second amplifier 423, while matching the drive signal in waveform, phase, and frequency. The branched drive signal branched from the first amplifier 422 is fed to the amplitude regulator 451 of the anomaly detection unit 45. The branched drive signal output from the driver 42 to the amplitude regulator 451 may be replaced with the original drive signal.

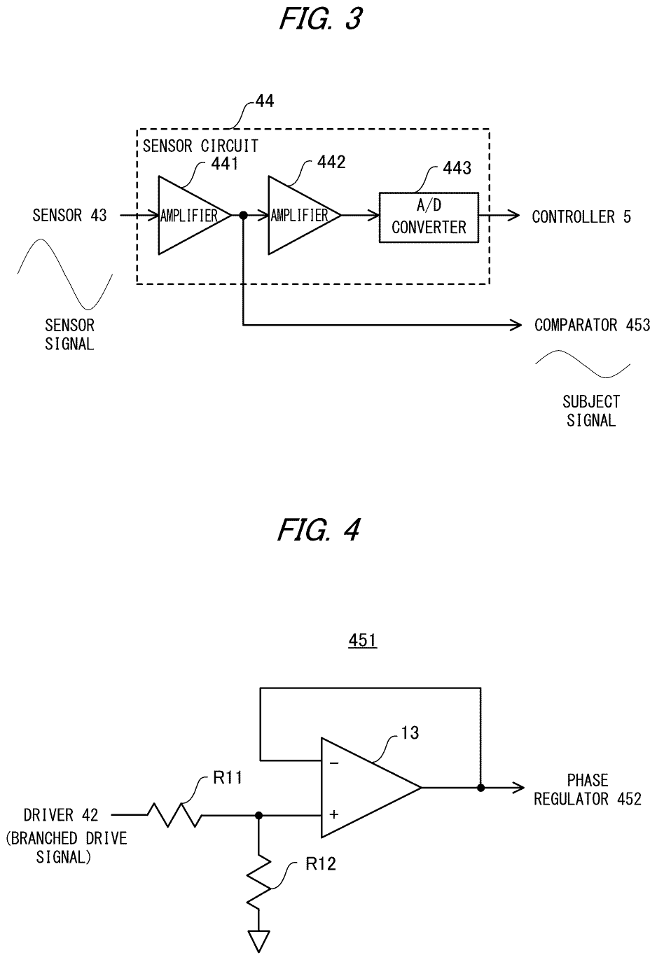

FIG. 3 is a block diagram illustrating exemplary specific components of the sensor circuit 44. The sensor circuit 44 includes a first amplifier 441 that amplifies the sensor signal output from the sensor 43, a second amplifier 442, and an A/D converter 443. The sensor signal from the sensor 43 is amplified by the first amplifier 441 and the second amplifier 442, converted into digital data by the A/D converter 443, and output to the controller 5. The sensor signal is converted into digital data by sampling the sensor signal at the sampling frequency of the A/D converter 443. The sensor circuit 44 includes an output branching from the signal path between the output of the first amplifier 441 and the input of the second amplifier 442, to output a subject signal from the branching output. The subject signal, which is output from the first amplifier 441, is an analog signal having an amplitude ratio smaller than that of the signal input to the A/D converter 443 by a factor corresponding to the degree of amplification of the second amplifier 442, while matching the input signal in phase and frequency. The subject signal branched from the first amplifier 441 is fed to the comparator 453 of the anomaly detection unit 45.

FIG. 4 illustrates exemplary specific components of the amplitude regulator 451. The amplitude regulator 451 adjusts the amplitude of the branched drive signal from the driver 42, to generate the reference signal to be compared with the subject signal from the sensor circuit 44. As illustrated in FIG. 4, the amplitude regulator 451 is a circuit that adjusts the amplitude of the branched drive signal by dividing its voltage using resistors R11 and R12 and applying the resulting voltage to the non-inverting terminal of the operational amplifier 13. This circuit can adjust the amplitude by changing the ratio between the resistors R11 and R12. As an exemplary method for changing the constants of the resistors R11 and R12, these resistors R11 and R12 may be implemented as adjustable components, such as digital potentiometers. In this example, the controller 5 detects the amplitude of the sensor signal, and adjusts the resistance values of the resistors R11 and R12 such that the resulting signal has the same amplitude as the subject signal input to the comparator 453. Alternatively, the resistors R11 and R12 may be fixed resistors having resistance values adjusted to individual systems. The amplitude is detected in a specific situation, such as shipment, adjustment and maintenance, or activation of the system. Although FIG. 4 illustrates a circuit that adjusts the amplitude of the branched drive signal by dividing its voltage using the resistors R11 and R12 and applying the resulting voltage to the non-inverting terminal of the operational amplifier 13, the amplitude may be adjusted not by voltage division, but by amplification. In this case, the circuit illustrated in FIG. 4 is modified by excluding the resistors R11 and R12 and connecting a negative feedback circuit to the inverting input terminal of the operational amplifier 13, for example. This modified circuit adjusts the amplitude by changing the constant of the negative feedback circuit.

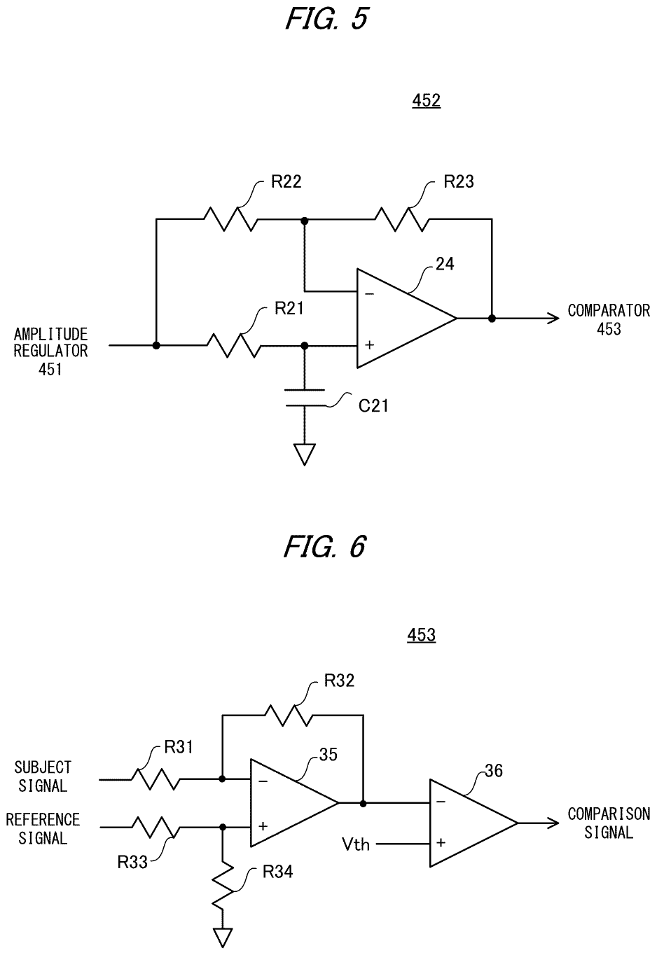

FIG. 5 illustrates exemplary specific components of the phase regulator 452. The phase regulator 452 adjusts the phase of the branched drive signal after the amplitude adjustment to be either substantially in phase or in antiphase with the subject signal indicating the detected motion

of the optical deflector 41 driven by the drive signal. Whether the phase is adjusted to be in phase or opposite phase depends on the configuration of the comparator 453. FIG. 5 illustrates a circuit that changes the phase characteristics alone of the input signal while maintaining its amplitude characteristics, using an all-pass filter. The circuit includes a resistor R22 serving as an input resistor, and a resistor R23 serving as a feedback resister. The circuit applies negative feedback by routing the output from an operational amplifier 24 to its inverting input terminal. The circuit also includes a resistor R21 and a capacitor C21 that form an RC circuit. The circuit adjusts the phase of the input signal by changing the constants of the resistor R21 and the capacitor C21, and thus generates the reference signal. As an exemplary method for changing the constants of the resistor R21 and the capacitor C21, the resistor R21 and the capacitor C21 may be implemented as adjustable components, such as a digital potentiometer and a variable capacitor. In this example, the controller 5 detects the phase difference between the sensor signal and the drive signal and adjusts the resistance and capacitance values. Alternatively, the resistor R21 and the capacitor C21 may respectively be a fixed resistor and a fixed capacitor having resistance and capacitance values adjusted suitably for individual systems. The phase is detected in a specific situation, such as shipment, adjustment and maintenance, or activation of the system.

FIG. 6 illustrates exemplary specific components of the comparator 453. The comparator 453 compares the subject signal with the reference signal, and outputs the comparison signal. This description assumes that the phase regulator 452 adjusts the phase of the branched drive signal after the amplitude adjustment to be in phase with the subject signal. FIG. 6 illustrates a circuit including a differential circuit in the preceding stage and a comparison circuit in the subsequent stage. The preceding differential circuit includes a resistor R31 connected to the inverting input terminal of an operational amplifier 35, resistors R33 and R34 connected to its non-inverting terminal, and a resistor R32 serving as a feedback resister. The subsequent comparison circuit includes an operational amplifier 36 having the non-inverting terminal fed with a threshold voltage Vth, and the inverting input terminal fed with the signal output from the differential circuit. The inverting terminal in the preceding differential circuit is fed with the subject signal, while the non-inverting terminal is fed with the reference signal. The preceding differential circuit generates a differential signal between the subject signal and the reference signal, and the subsequent comparison circuit compares the differential signal with the threshold voltage Vth and outputs the comparison signal. The comparator 453 may include an adder circuit in place of the preceding differential circuit. In this case, the above-described phase regulator 452 adjusts the phase of the branched drive signal after the amplitude adjustment to be in antiphase with the subject signal.

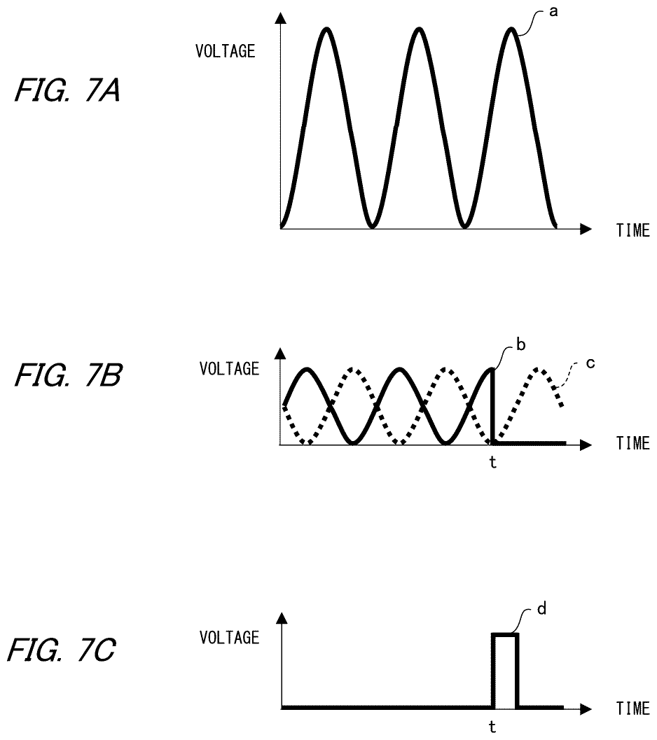

FIG. 7 is a set of schematic diagrams each illustrating an input or output waveform of each functional block of the driving device 4. FIG. 7A is a waveform diagram illustrating a branched drive signal a output from the driver 42 during driving of the optical deflector 41 in the lighting system 1 illustrated in FIG. 1; FIG. 7B is a waveform diagram illustrating a subject signal b and a reference signal c input to the comparator 453; and FIG. 7C is a waveform diagram illustrating a comparison signal d output from the comparator 453. The description assumes that the subject signal b and the reference signal c are in antiphase with each other in the normal state, and the comparator 453 includes an adder circuit as the operational amplifier 35.

The optical deflector 41 operates in accordance with the drive signal. The sensor 43 of the optical deflector 41 outputs the sensor signal indicating the mechanical motion of the optical deflector 41. The output sensor signal thus has the same frequency as the drive signal and exhibits a constant amplitude ratio and a constant phase difference under normal operation of the optical deflector 41. The drive signal after the amplitude and phase adjustment can thus be used as the reference signal indicating the motion of the optical deflector 41 in the normal operation. The reference signal is generated by adjusting the amplitude and phase of the branched drive signal, branched from the drive signal in the driver 42 and matching the drive signal in waveform

and frequency, such that the reference signal has the same amplitude and phase difference as the subject signal indicating the motion of the optical deflector 41 in the normal operation. The resulting reference signal and the subject signal branched from the sensor circuit 44 are compared with each other, to yield a comparison signal that varies in response to any anomaly, such as failure, in the optical deflector 41, thereby enabling detection of an anomaly in the optical deflector 41.

Relative to the branched drive signal a illustrated in FIG. 7A, the subject signal b illustrated in FIG. 7B until a time t has the same frequency and exhibits a constant amplitude ratio and a constant phase difference. The reference signal c is adjusted to have the same amplitude and phase difference as the subject signal indicating the motion of the optical deflector 41 in the normal operation. The reference signal c and the subject signal b thus have the same frequency and amplitude and have a phase difference of 180°. This relationship between the subject signal b and the reference signal c until the time t provides the constant comparison signal d, which implies the optical deflector 41 in the normal operation, as illustrated in FIG. 7C. When the current time reaches the time t of occurrence of a failure in the optical deflector 41, the subject signal b suddenly drops. This voltage drop varies the comparison signal d, triggering detection of an anomaly in the optical deflector 41.

The lighting system 1 including a laser source as the light source 2 needs to instantly detect an anomaly in the optical deflector 41 and terminate laser emission. The following assumes an example in which the optical deflector 41 for steering a 0.1 W visible-light laser beam (wavelength: 400 to 700 nm) stops scanning due to a failure in the optical deflector 41 and constantly emits the laser beam onto a fixed point. To safely stop laser emission, the lighting system 1 must control the pulse energy to 77 nJ or lower. That is, the lighting system 1 must terminate laser emission within a period of approximately 770 ns or shorter. Since anomality detection precedes the termination of laser emission, the lighting system 1 needs to complete anomality detection within a shorter time than this period. This period is inversely proportional to the laser power within a certain power range. For example, the period must be approximately 154 ns or shorter when using a 0.5 W visible-light laser beam.

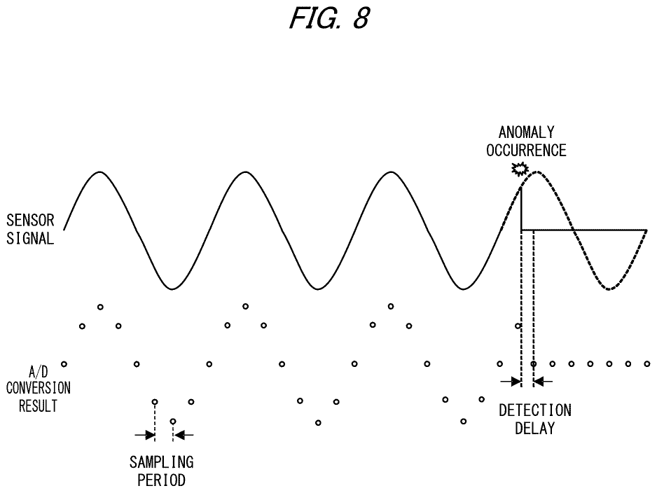

FIG. 8 illustrates a comparative example in which an existing system detects an anomaly from a result of conversion by an A/D converter. FIG. 8 illustrates a sensor signal and digital data generated by A/D converting the sensor signal. The A/D conversion of the sensor signal by the A/D converter involves sampling data in accordance with the sampling period of the A/D converter. The existing system thus cannot instantly detect a signal indicating an anomaly occurring at a timing between two sampling times, resulting in a detection delay. In the anomality detection from the result of conversion by the A/D converter, the guaranteed detection time cannot be shorter than the A/D conversion period, because the anomaly detection process for the optical deflector 41 and the A/D conversion process are asynchronous. The detection can be accelerated by using an efficient high-speed A/D converter having a high sampling frequency, but such a high-speed A/D converter is approximately 10 to 100 times more expensive than a comparator operating at the same speed. In contrast, the lighting system 1 according to the present disclosure can achieve high-speed anomaly detection in the optical deflector 41 without an expensive high-speed A/D converter. The lighting system 1 can thus instantly terminate laser emission in response to occurrence of an anomaly, thereby ensuring the safety at low costs.

### Modification 1

In the above-described embodiment, the subject signal is compared with the reference signal generated by adjusting the amplitude and phase of the branched drive signal to detect an anomaly, such as failure. In addition, a system according to a modification detects an anomaly on the basis of sensor data generated by A/D converting the sensor signal. The sensor signal is A/D converted in the sensor circuit 44 and then input to the controller 5. The controller 5 monitors variations in the sensor signal on the basis of the input sensor data, to detect an anomaly. The system is configured to detect failures occurring in a short period using the comparison signal resulting from comparison between the reference signal and the subject signal, and detect failures and degradation occurring in a long period using the sensor data generated by A/D converting the sensor signal. This system can detect both long-term degradation and instantaneous failures. In this modification, the controller 5 monitors the sensor data generated by A/D converting the sensor signal for a long period. Using the amplitude of the sensor signal acquired though the long-term monitoring, the system can change the value of amplitude of the branched drive signal to be adjusted by the amplitude regulator 451 to an appropriate value. The system can also change the value of phase of the branched drive signal to be adjusted by the phase regulator 452 to an appropriate value, using the phase of the sensor signal acquired though the long-term monitoring.

### Modification 2

The system may be able to change the amplitude of the drive signal for driving the actuator of the optical deflector 41. The controller 5 provides the driver 42 with drive data for generation of a drive signal, containing data instructing the driver 42 to change the amplitude of the drive signal. This instructing data causes a change in the amplitude of the drive signal output from the driver 42. In response to a change in the amplitude of the drive signal, the controller 5 temporarily invalidates the anomaly detecting process executed by the anomaly detection unit 45. Such a change in the amplitude of the drive signal modifies the branched drive signal, so that the amplitude regulator 451 may fail to appropriately adjust the amplitude of the branched drive signal. The inappropriate amplitude adjustment may result in generation of an improper reference signal, thereby inhibiting accurate anomaly detection. To avoid such misdetection, the controller 5 invalidates the anomaly detecting process executed by the anomaly detection unit 45 within a certain period after the amplitude change. The controller 5 prepares the amplitude regulator 451 and the phase regulator 452 after the amplitude change, and then revalidates the anomaly detecting process. The adjustment values in this step are determined depending on the adjusted value of amplitude of the drive signal. For example, the adjustment values are determined using the adjusted value of amplitude as a coefficient, or determined with reference to a predetermined table. Alternatively, the adjustment values are determined in accordance with the sensor signal received by the sensor circuit 44.

### Modification 3

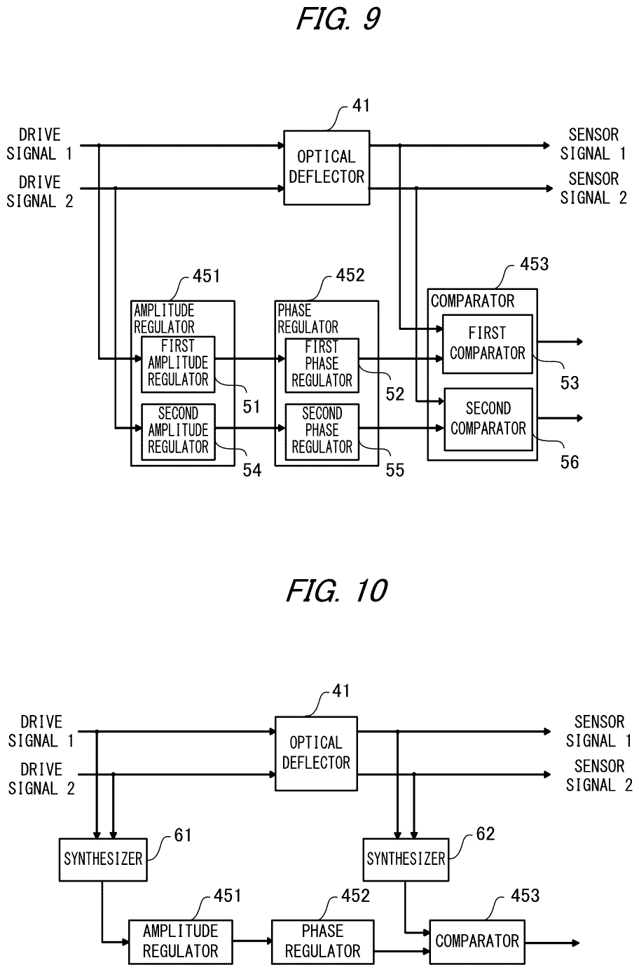

The anomaly detection in the above-described embodiment uses the single sensor 43 to detect a motion of the optical deflector 41 that responds to a single drive signal. In contrast, the system may include two or more sensors 43 to detect motions of the optical deflector 41 that respond to two or more drive signals, and detect an anomaly on the basis of the sensor signals detected by the respective sensors 43. FIG. 9 illustrates an exemplary driving device that detects an anomaly on the basis of sensor signals 1 and 2 indicating detected motions of the optical deflector 41 that respond to two drive signals 1 and 2 applied to the actuator of the optical deflector 41. The amplitude regulator 451 and the phase regulator 452 receive both the drive signals 1 and 2, followed by adjustment of the amplitude and phase of the drive signal 1 by a first amplitude regulator 51 in the amplitude regulator 451 and a first phase regulator 52 in the phase regulator 452, as well as adjustment of the amplitude and phase of the drive signal 2 by a second amplitude regulator 54 in the amplitude regulator 451 and a second phase regulator 55 in the phase regulator 452. The reference signal generated by adjusting the amplitude and phase of the drive signal 1 is input to a first comparator 53 in the comparator 453, whereas the reference signal generated by adjusting the amplitude and phase of the drive signal 2 is input to a second comparator 56 in the comparator 453. The first comparator 53 receives the sensor signal 1 and thus outputs a comparison signal resulting from comparison between the sensor signal 1 and the reference signal, thereby enabling anomaly detection based on the sensor signal 1. The second comparator 56 receives the sensor signal 2 and outputs a comparison signal resulting from comparison between the sensor signal 2 and the reference signal, thereby enabling anomaly detection based on the sensor signal 2. The drive signal 1 input to the first amplitude regulator 51 may be replaced with a branched drive signal 1 output from the driver 42 that matches the drive signal 1 in waveform and frequency. Also, the drive signal 2 input to the second amplitude regulator 54 may be replaced with a branched drive signal 2 output from the driver 42 that matches the drive signal 2 in waveform and frequency.

### Modification 4

The anomaly detection in Modification 3 is separately performed for the individual sensor signals associated with two or more drive signals. In contrast, a system in Modification 4 performs adjustment and comparison after synthesizing two or more drive signals into a single signal and synthesizing sensor signals associated with the drive signals into a single signal. FIG. 10 illustrates an exemplary driving device 4 that outputs sensor signals 1 and 2 indicating detected motions of the optical deflector 41 that respond to drive signals 1 and 2 applied to the actuator of the optical deflector 41. The two drive signals 1 and 2 are input to a synthesizer 61 and synthesized into a single signal. Also, the two sensor signals 1 and 2 are input to a synthesizer 62 and synthesized into a single signal. Examples of the synthesizers 61 and 62 include differential circuits and adder circuits. The drive signal synthesized by the synthesizer 61 is input to the amplitude regulator 451 and the phase regulator 452 for amplitude and phase adjustment, thereby yielding a reference signal. The resulting reference signal is input to the comparator 453. The sensor signal synthesized by the synthesizer 62 is also input to the comparator 453 to be used in anomaly detection. This system can process two or more drive signals or sensor signals collectively as a single signal, and thus detect an anomaly in a simple procedure. The drive signal 1 may be replaced with a branched drive signal 1 output from the driver 42 that matches the drive signal 1 in waveform and frequency. Also, the drive signal 2 may be replaced with a branched drive signal 2 output from the driver 42 that matches the drive signal 2 in waveform and frequency.

### Modification 5

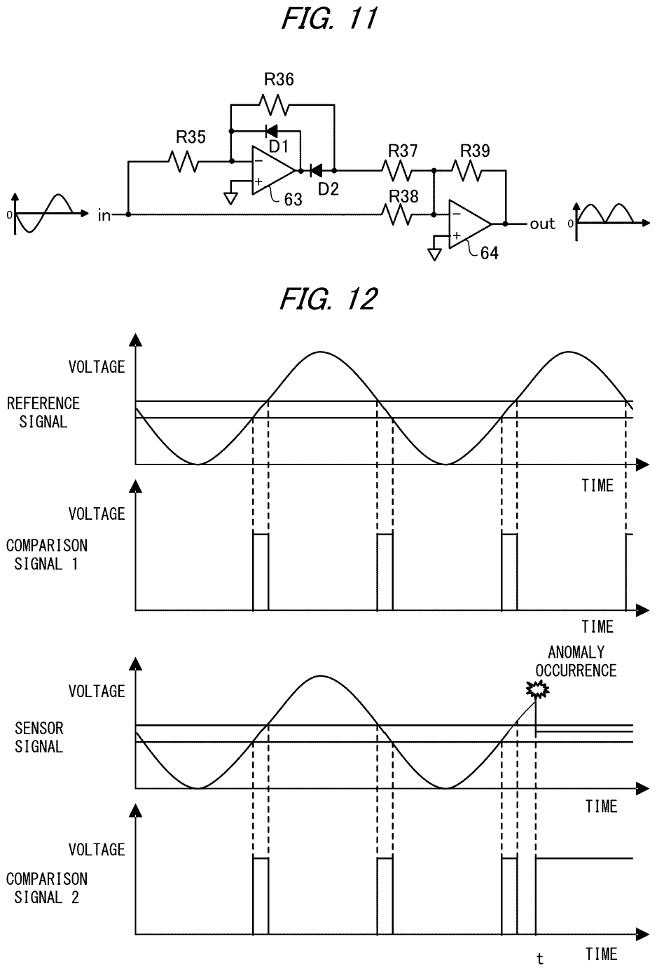

The comparator 453 may compare the absolute values of signals. FIG. 11 illustrates an exemplary absolute value circuit for the comparator 453 that compares the absolute values of signals. The absolute value circuit includes a half-wave rectifier circuit including an operational amplifier 63, resistors R35 and R36, and diodes D1 and D2, and an adder circuit including an operational amplifier 64 and resistors R37, R38, and R39. This absolute value circuit can convert positive or negative input signals into absolute value signals to be compared.

### Modification 6

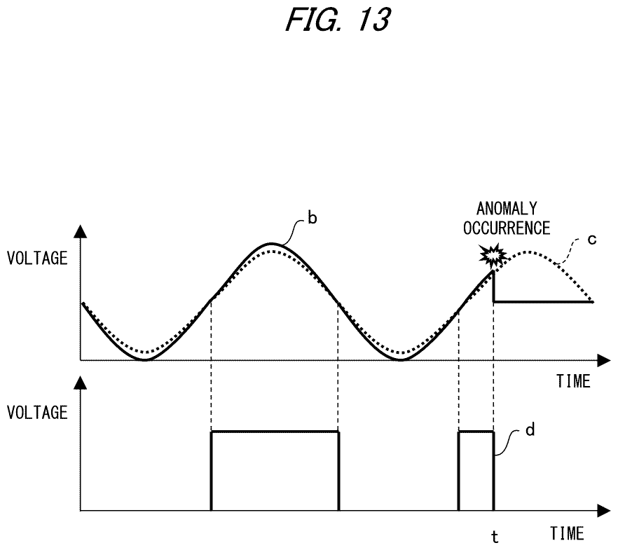

The comparator 453 in the above-described embodiment directly compares the reference signal and the sensor signal. In contrast, the comparator 453 in Modification 6 compares each of the reference signal and the sensor signal with a predetermined voltage value or range, and outputs a comparison signal 1 or 2. On the basis of these comparison signals 1 and 2, the controller 5 detects an anomaly, such as failure. FIG. 12 illustrates waveforms of the reference signal, the comparison signal 1, the sensor signal, and the comparison signal 2. The comparison signal 1 indicates “1” when the reference signal is within a predetermined voltage range. The comparison signal 2 indicates “1” when the sensor signal is within a predetermined voltage range. These comparison signals 1 and 2 have no difference in the normal state, because the sensor signal matches the reference signal in frequency, phase, and amplitude. This example assumes occurrence of an anomaly at a time t, so that the sensor signal suddenly drops to a value within the predetermined voltage range. This voltage drop causes the comparison signal 2 to indicate “1” constantly from the time t. The comparison signal 2 indicating “1” from the time t does not match the comparison signal 1. In accordance with such a difference between the comparison signals 1 and 2 caused by occurrence of an anomaly, such as failure, the controller 5 can detect the anomaly by comparing the two signals.

### Modification 7

The comparator 453 may input the reference signal and the subject signal directly to a comparison circuit and output a comparison signal indicating a result of the comparison. In the example illustrated in FIG. 13, the amplitude of the reference signal c is adjusted slightly lower than that of the subject signal b. When the subject signal b and the reference signal c having this relationship are compared directly to each other by a comparison circuit, the resulting comparison signal d in the normal state repetitively indicates “1” and “0” in a duty cycle of 50%. This example assumes occurrence of an anomaly at a time t, so that the subject signal b suddenly drops, thereby switching the comparison signal d from “1” to “0”. The comparison signal d thus has a duty cycle deviated from 50%. In accordance with such a transition of the comparison signal d from “1” to “0 ” in a duty cycle deviated from 50%, the system can detect an anomaly.

Although the above description of the embodiment illustrates an exemplary drive signal having a sign waveform, the drive signal may have any waveform, such as triangular or ramp waveform, other than sine waveform, provided that the drive signal has a periodically varying voltage.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A driving device, comprising:
a driven mechanism to be driven by a drive signal to operate with a mechanical motion;
a driver to output the drive signal;
a sensor circuit to output a subject signal, the subject signal corresponding to a voltage generated by a sensor included in the driven mechanism, the voltage varying in accordance with operation of the driven mechanism;
a regulator to adjust an amplitude and a phase of a signal from the driver, and thus generate a reference signal; and
a comparator to compare the reference signal and the subject signal, and output a comparison signal for detection of an anomaly in the driven mechanism.

2. The driving device according to claim 1, further comprising:
a determiner to determine, based on the comparison signal, an anomaly in the driven mechanism.

3. The driving device according to claim 1, wherein the reference signal has a same amplitude as the subject signal and is either in phase or in antiphase with the subject signal, the subject signal being output while the driven mechanism is operating properly.

4. The driving device according to claim 1, further comprising:
a controller to determine values of the amplitude and the phase to be adjusted by the regulator, wherein
the sensor circuit outputs sensor data to the controller, the sensor data being generated by A/D converting the voltage generated by the sensor, and
the controller determines, based on the sensor data, the values of the amplitude and the phase to be adjusted by the regulator.

5. The driving device according to claim 4, wherein the controller
invalidates an anomaly detecting process for the driven mechanism using the comparison signal,
adjusts the amplitude of the signal from the driver,
determines, based on an adjusted value of the amplitude of the signal from the driver, the values to be adjusted by the regulator, and then
revalidates the anomaly detecting process.

6. The driving device according to claim 1, further comprising:
a controller to detect an anomaly resulting of long-term degradation of the driven mechanism, wherein
the sensor circuit outputs sensor data to the controller, the sensor data being generated by A/D converting the voltage generated by the sensor, and
the controller detects, based on long-term variations in the sensor data, an anomaly in the driven mechanism.

7. The driving device according to claim 1, wherein the signal from the driver is a branched drive signal having a same waveform and a same frequency as the drive signal.

8. The driving device according to claim 1, wherein the signal from the driver is the drive signal.

9. The driving device according to claim 1, wherein the driven mechanism is an optical deflector.
